(19) United States
(12) Patent Application Publication
(10) Pub. No.: US 2015/0023507 A1
(43) Pub. Date: Jan. 22, 2015

(54) Speaker Protection in Small Form Factor Devices

(71) Applicant: Nvidia Corporation, Santa Clara, CA (US)

(72) Inventor: Anil Ubale, Cupertino, CA (US)

(21) Appl. No.: 13/946,811

(22) Filed: Jul. 19, 2013

(51) Int. Cl. H04R 3/00

(52) U.S. Cl. CPC H04R 3/007
USPC 381/55

(57) ABSTRACT

An audio engine applies a driving signal to a speaker system, which produces an audio signal. The audio signal is captured by a microphone on the same device and feeds that signal back to the audio engine. After comparing the recorded signal to an expected signal the variance is assessed to determine the presence of distortion, in which case subsequent driving signals are attenuated to avoid damage to the speaker system.

### BACKGROUND

One contemporary trend in the design of computing systems is the development of portable devices in ever smaller form factors. Among other things, this means that the audio components of these devices are very small and thus more susceptible to damage when driven by relatively high-powered signals. Users prefer such high-powered signals in order to deliver audio that is both loud and of high quality. Accordingly, there is a need for some mechanism to prevent damage to audio components—e.g., overheating of the speaker coil, tearing of the speaker cone, etc.

One solution is to provide feed-forward control limitations on certain aspects of the driving signal (the term “driving signal” is used herein to denote the electrical signal applied to a speaker system to generate an audio signal), e.g., clipping signals when power exceeds predetermined thresholds. One problem with feed-forward solutions is that they necessarily have to err on the side of being conservative. The conservative approach is therefore necessarily “over-inclusive,” in the sense that some signals are attenuated even though they may not cause damage.

Another solution, which is perhaps more effective, is to employ a feedback scheme in which voltage and/or current through the voice coil is sensed. When these parameters exceed thresholds, the system correctively attenuates the driving signal to protect the voice coil and speaker cone. While effective at preventing damage, this method introduces additional components and complexity into the system.

### BRIEF DESCRIPTION OF THE DRAWINGS

FIG. 1 is a block diagram illustrating an exemplary electronic device in which the present invention may be implemented and where an additional microphone is available to assist in cancelling ambient noise from the recorded output.

FIG. 2 is a block diagram illustrating an exemplary audio engine in which scalar gain adjustment is used to adjust the overall amplitude of the driving signal.

FIG. 3 is a block diagram illustrating an exemplary audio engine in which multi-band gain adjustment is used to adjust individual frequency band amplitudes of the driving signal.

FIG. 4 is a block diagram illustrating an exemplary audio engine in which an FIR filter applies frequency selective gain adjustment on the amplitude of the driving signal.

FIG. 5 is a flow chart representing an example of the manner in which the present invention can be used to determine whether the driving signal should be attenuated.

### DETAILED DESCRIPTION

This disclosure is directed to novel systems and methods for protecting audio components of an electronic device from damage. The types of damage that are specifically contemplated are (i) overheating or burning out of the speaker system voice coil; and/or (ii) tearing, rupture or other physical damage to the speaker diaphragm. The potential for damage arises from two competing design/performance factors. First, the electronic devices in which speaker systems are implemented are being provided in ever-smaller form factors. Voice coils and speaker diaphragms typically are quite small in these systems. In addition to demanding very small and portable devices, consumers want audio output that is both loud and of high quality. The volume/quality goals are pursued by driving the speaker system with high-power driving signals that are more apt to cause the damage described above. To mitigate this, various control regimes are employed to selectively attenuate the driving signals.

The control regime of the present disclosure employs a feedback mechanism that can be implemented without adding complexity and additional components to the system. Smartphones and other portable devices typically have one or more microphones. Some such devices use a multiple-microphone configuration to sense and filter out ambient noise prior to transmission to far-end caller during a voice-call. The control regime described herein leverages these existing components to dynamically sense overdrive/distortion conditions and in response appropriately attenuate the signals applied to the voice coil to drive the speaker cone. Specifically, the one or more existing microphones are used to sense the audio output of the speaker system. The recorded output is fed back to an audio engine which analyzes the output to determine whether it deviates by more than a threshold from an expected output which would occur in the absence of distortion. If the threshold is exceeded, the system dynamically adjusts in real time to trim the driving signals and thereby protect the speaker components. In multiple microphone configurations, differential audio signals can be employed to filter out ambient noise and get a more accurate sense of how the system is performing (e.g., whether distortion is occurring).

In a perfectly quiet environment the recorded output from the near microphone is sufficient to detect the distortions introduced due to overdriving of the speaker. However, when the playback occurs in a noisy environment, comparing recorded audio output signal from near microphone alone may result in false detection of distortions. This will result in attenuation being applied to the driving signal when it is not necessary. This is undesirable because users would typically set higher volume setting in such scenario and expect louder sound. The invention uses recorded output(s) from other existing distant microphone(s) in the device to estimate the frequency spectrum and overall energy of the ambient noise and accounts for it in the analysis module before estimating the distortion level and frequency spectrum in the audio output.

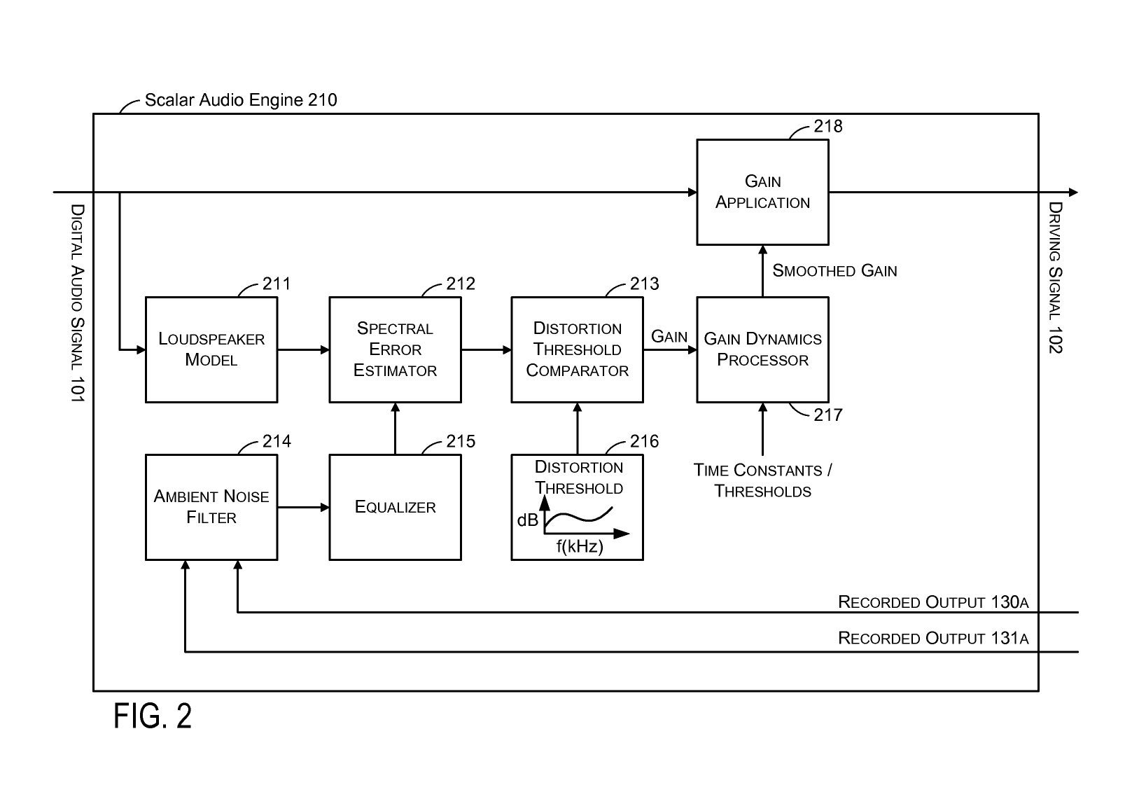

The details of the algorithms inside the audio engine are described in FIGS. 2, 3 and 4. There are various ways of correcting the incoming digital audio signal before sending it to the loudspeaker. A simple example involves using a scalar gain audio engine. The gains are typically calculated every frame, each containing a number of audio samples of the order of 0.5-1 ms long. As the gains may change from frame-to-frame, audible artifacts may appear that can be smoothed out by a dynamic gain processor prior to applying the digital audio signal. In other circumstances it may be advantageous to apply the gain selectively to different frequency regions of the digital audio signals and attenuate only those frequency bands that violate the distortion thresholds. It should be noted that the spectral balance of the signal should be changed smoothly over time and frequency in order to avoid audible artifacts. The multi-band approach is a more complex example that requires that the input audio signal be split into frequency bands and this introduces latency in the forward playback path. For applications that are latency sensitive, such as voice-call, low-latency filter-banks can be used for frequency splitting. Additionally, the frequency selective gain can also be applied by approximating the band gains by a finite-impulse response (FIR) transfer function. In a third example, the digital audio signal is modified by a time-varying FIR filter processing to meet the distortion criterion. Similar to the gain applications, the frame-by-frame coefficients of the FIR filter are interpolated in time to avoid rapid changes in the audio spectrum that could lead to audible artifacts.

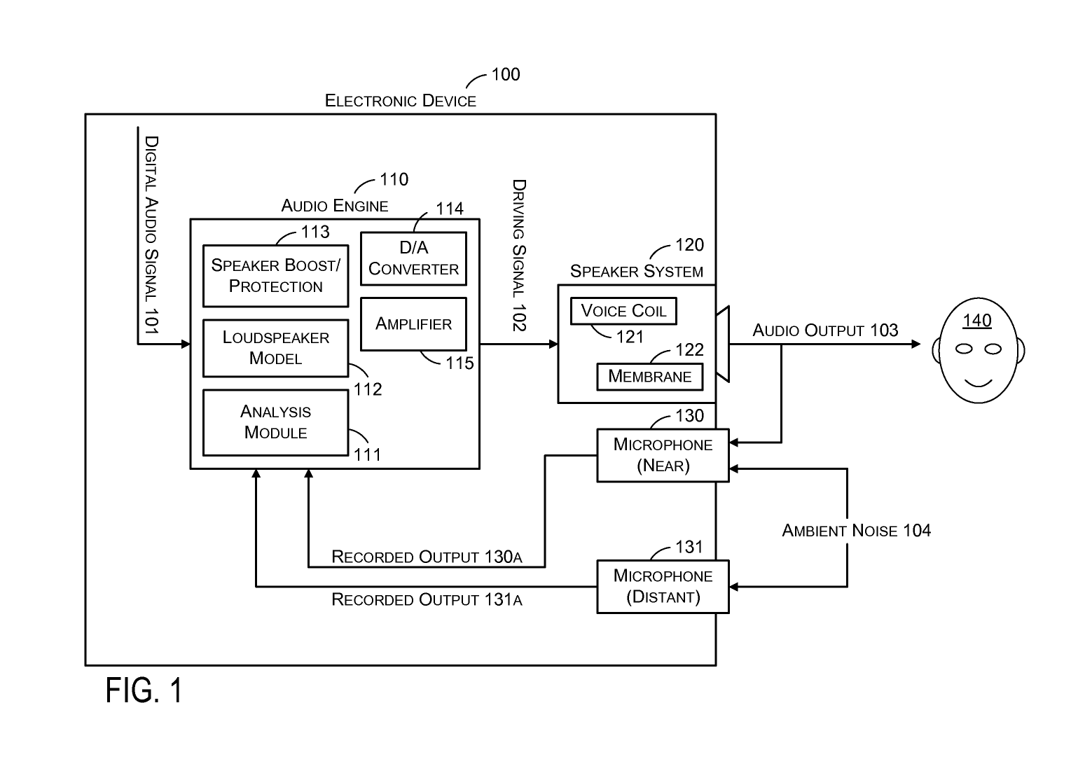

Turning now to the figures, FIG. 1 schematically depicts an example of an audio system in accordance with the present disclosure. A digital audio signal 101 is applied to audio engine 110 which generates driving signal 102 that is applied to speaker system 120. The driving signal creates electrical conditions in voice coil 121 (e.g., voltages and currents) that cause speaker membrane 122 to vibrate and thereby generate audio output 103 perceivable by user 140.

In the present example the audio engine includes D/A converter 114 and amplifier 115, which are operative to convert a digital signal into a corresponding amplified signal that drives speaker system 120. These components typically will interact with loudspeaker model 112, which is an electronic characterization of the properties of speaker system 120. The speaker model influences the D/A conversion process and the amplification so that the driving signal is appropriately tuned to the specific characteristics of the speaker system. As will be described in more detail, the audio engine typically also includes an analysis module 111 for analyzing audio sensed by one or more microphones. The present example also includes microphone 130 and microphone 131, which will be described in more detail below.

Electronic device 100 may include a housing, with the speaker membrane and microphones being positioned on the housing in specific locations relative to one another. In particular, microphone 130 may be located near speaker membrane 122 (i.e., closer to the speaker membrane than microphone 131). The microphones may therefore be respectively considered and referred to as the “near-speaker” microphone and the “distant” microphone.

The relative locations of the microphones affect how they sense the audio output 103 from speaker system 120. Specifically, microphone 130 picks up the audio output from speaker membrane 122 much more strongly than microphone 131. Distant microphone 131 picks up some of the audio output from the speaker membrane but to simplify this discussion and illustrate the principles of the invention, it is shown as picking up only ambient noise 104. In contrast, microphone 130 picks up both ambient noise 104 and the audio output from speaker membrane 122. Both microphones are for all practical purposes in the same position relative to sources of ambient noise, such that they both pick up the ambient noise at the same volume levels. In the case that the microphones are analog, D/A converter 114 processes each signal into a recorded output. However, a DSP decimator may be used in the case of digital microphones.

In any event, the microphones provide recorded output to analysis module 111. As described above, the recorded output 130A from near microphone 130 includes both ambient noise and the audio output from the speaker membrane. The recorded output 131_{A} of distant microphone 131 includes only the ambient noise. It should then be understood that analysis module 111 can compare these recorded outputs in order to subtract out the ambient noise and provide the audio engine 110 with a more accurate representation of the speaker system audio output 103.

The present system further contemplates that the audio output 103 for a given driving signal 102 can be accurately predicted. Accordingly, if there is some deviation from the expected output, it can be assumed that the deviation is a result of overdrive/distortion or other undesired output. In one aspect, the novel system/method herein can be described as follows: (1) the audio engine uses the loudspeaker model 112 to generate a non-attenuated driving signal 102; (2) the driving signal creates electrical conditions on voice coil 121 so as to drive speaker membrane 122 to produce an audio output 103; (3) microphones 130 and 131 pick up the audio output and ambient noise; (4) the recorded output from the microphones is analyzed by analysis module and the ambient noise is filtered out to gain an accurate representation and understanding of the audio output; (5) the analysis module determines whether the audio output deviates from what would be expected in the absence of overdrive/distortion; (6) if the audio output deviates from expectations by more than a threshold amount, the speaker protection module and loudspeaker work together so that a subsequent driving signal is attenuated in a manner to guard against damage to speaker coil 121 and/or speaker membrane 122. In the case that the distortion is only detected in one or more specific frequencies, attenuation can be applied selectively to those frequency bands. If determined by audio engine 110 that attenuating only parts of the driving signal would negatively affect the audio signal's quality the overall gain of the driving signal can be attenuated.

The unpredictability of audio signal 103's content can make detecting distortions prior to audio component damage less reliable. To counter this a pilot tone can be added to the driving signal at a frequency outside or nearly outside the audible range, creating an audio signal component that is more likely to generate detectable distortions if the speaker system is introducing distortions.

Moving on to FIG. 2, the block diagram shows a non-limiting example of an audio engine utilizing scalar gain adjustment as described above. Initially digital audio signal 101 enters audio engine 210 and passes through gain application 218, which converts the signal into driving signal 102. The microphone array detects the output from the speaker and returns recorded output 130_{A} from a microphone near the speaker and recorded output 131_{A} from a more distant microphone. The recorded outputs are processed by ambient noise filter 214 which estimates the ambient noise by comparing the two signals and filters that estimate from recorded output 130_{A}, which is expected to contain the possible distortions. The resulting filtered signal is sent to equalizer 215 to adjust the amplitude to match the expected output generated by loudspeaker model 211 when supplied with digital audio signal 101. The filtered and equalized recorded output and the expected output are sent to spectral error estimator 212 to determine the difference between them. The result is sent to distortion threshold comparator 213 along with distortion threshold 216. If the spectral error exceeds the distortion threshold a gain value is sent to gain dynamics processor 217, which incorporates pre-determined time constraints and/or thresholds before applying the smoothed gain value to gain application 218. As the subsequent digital audio signal reaches the gain application, it is attenuated based on the smoothed gain value and the process repeats.

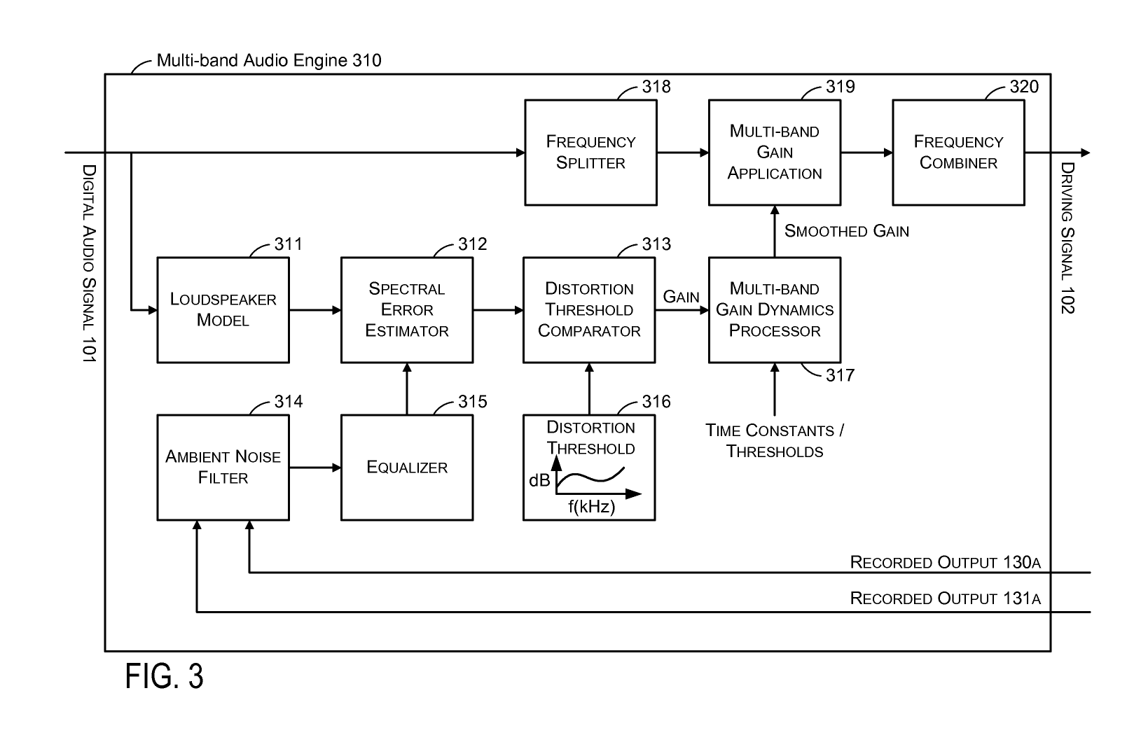

The non-limiting example of an audio engine utilizing multi-band gain adjustment is found in FIG. 3. In this case digital audio signal 101 is sent to frequency splitter 318, where the signal is broken down into frequency bands and processed individually by multiband gain application 319. Each band has a gain applied to it from multi-band gain dynamics processor 317 before they're sent to frequency combiner 320. The other components of this example: loudspeaker model 311, spectral error estimator 312, distortion threshold comparator 313, ambient noise filter 314, equalizer 315 and distortion threshold 316 can be assumed to operate similarly to their analogs in the example in FIG. 2, although it should be realized that these components in this configuration represent only one way of accomplishing this task.

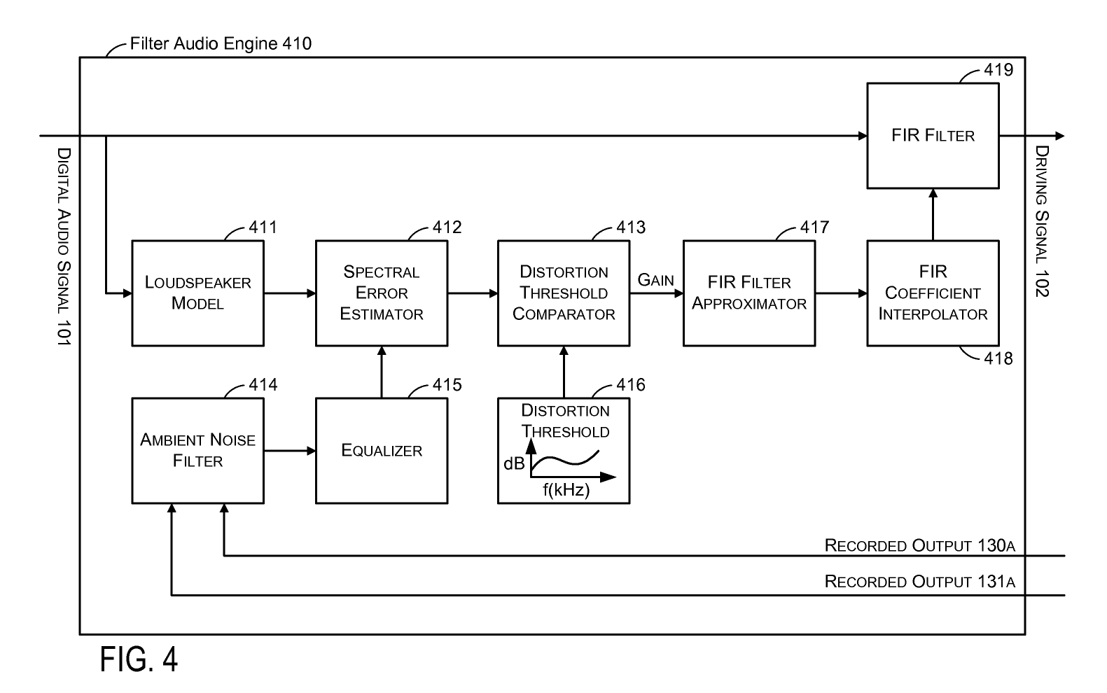

Additionally, FIG. 4 shows a third non-limiting example of an audio engine where FIR filter 419 selectively attenuates frequency bands by approximating band gains provided by FIR coefficient interpolator 418. The interpolator takes the data points provided when FIR filter approximator 417 analyzes the gain value created by distortion threshold comparator 416 and estimates what frequency ranges are responsible for the distortion detected. Those data points are interpolated into a frequency specific attenuation model used by the FIR filter. As above, in this example the remaining components: loudspeaker model 411, spectral error estimator 412, distortion threshold comparator 413, ambient noise filter 414, equalizer 415 and distortion threshold 416 can be assumed to operate similarly to their analogs in the example in FIG. 2, although it should be reiterated that these components in this configuration represent only one way of accomplishing this task.

It should be noted that due to the solution being primarily software driven, it also adds the capacity to easily update or make changes to the speaker protection being implemented on existing devices.

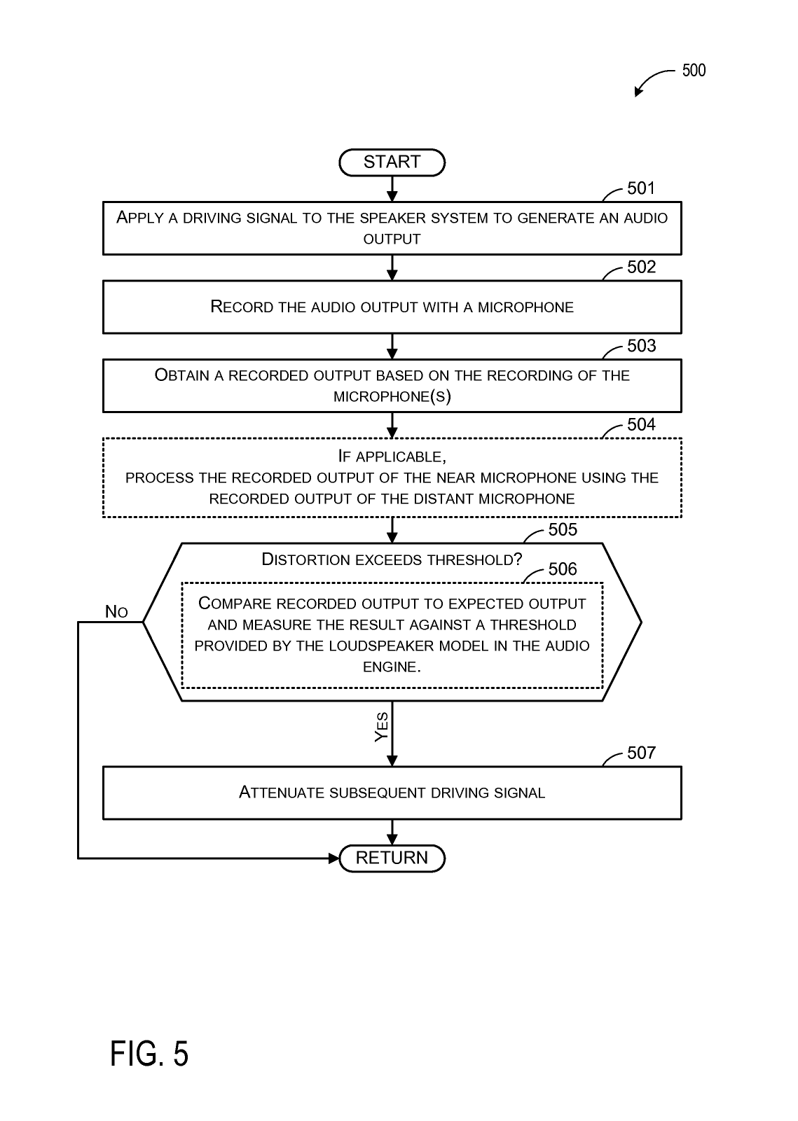

FIG. 5 is a flow chart representing an example of method 500, which details generating and recording an audio output and determining whether the subsequent driving signal should be attenuated. The following description references FIG. 1 to describe the different steps of the process. In step 501 of method 500, audio engine 110 applies driving signal 102 to speaker system 120. The signal interacts with voice coil 121 and membrane 122, depending on the type of speaker system being used, to generate audio signal 103. The audio signal intended for user 140 is recorded by microphone 130 in step 502 and obtained as recorded output 130_{A} in analysis module 111 in step 503. In the case of a multiple-microphone system, the ambient noise is filtered out of recorded output 130_{A} using recorded output 131_{A} from microphone 131 in step 504. The analysis module determines in step 505 if the distortion from the processed recorded output exceeds a threshold supplied by loudspeaker model 112. Step 506 shows that the distortion is isolated by comparing the processed recorded output to an expected output and looking for differences. If it does the subsequent driving signal is attenuated in step 507 and the process repeats. If it does not, the process repeats without attenuating the driving signal.

It should be noted that the present description is only one example of how the present invention may be implemented in an electronic device, but that it is not limited to this embodiment. The audio engine is depicted as including specific sub-components, but it will be understood that any selection and arrangement of components may be used so long as it generates a driving signal and can attenuate the driving signal based on recorded output from microphones of the device. In addition the speaker system is noted to have specific components and properties, but the method would be able to sense the distortions in the audio output regardless of the speaker system in place.

1. A method of protecting a speaker system of an electronic device against damage, the method comprising:
applying a driving signal to the speaker system to thereby generate an audio output from the speaker system;
recording the audio output with a microphone of the electronic device;
obtaining a recorded output that is based on the recording performed with the microphone;
processing the recorded output to determine whether and how the recorded output varies from an expected output which would occur in the absence of distortion; and
if the recorded output varies from the expected output by more than a threshold, attenuating an immediately subsequent driving signal prior to applying that subsequent driving signal to the speaker system.

2. The method of claim 1, where obtaining the recorded output includes filtering raw output from the microphone.

3. The method of claim 2, where filtering the raw output includes filtering out ambient noise based on audio recorded at an additional microphone that is spaced away from the microphone.

4. The method of claim 3, where the microphone is positioned closer to a speaker of the electronic device than the additional microphone.

5. The method of claim 1, where attenuating the subsequent driving signal includes attenuating specific frequencies.

6. The method of claim 1, where attenuating the subsequent driving signal includes modifying an overall gain employed in connection with producing the subsequent driving signal.

7. The method of claim 1, where determining whether the recorded output varies from the expected output by more than a threshold includes processing output from two or more microphones.

8. The method of claim 1, where determining whether the recorded output varies from the expected output by more than a threshold is determined with reference to a loudspeaker model stored in a memory location of the electronic device.

9. The method of claim 8, where the loudspeaker model is updatable to improve determination accuracy.

10. The method of claim 1, where a pilot tone is applied to the driving signal in order to produce easier to detect distortions provided the speaker system is operating nonlinearly.

11. An electronic device configured with a mechanism to protect audio components of the electronic device, comprising:
a speaker system;
an audio engine including an amplifier which supplies a driving signal to the speaker system so as to cause the speaker system to generate a perceivable audio output; and
a microphone configured to sense the audio output from the speaker system to thereby obtain and produce a recorded output;
where the audio engine is configured to (i) process the recorded output and determine whether and how the recorded output varies from an expected output which would occur in the absence of distortion, and (ii) if the recorded output varies from the expected output by more than a threshold, attenuate an immediately subsequent driving signal prior to applying that subsequent driving signal to the speaker system.

12. The electronic device of claim 11, where (i) the speaker system includes a speaker; (ii) the microphone is a near-speaker microphone; (iii) the electronic device further includes a distant microphone that is spaced farther away from the speaker than the near-speaker microphone; and (iv) output from both the near-speaker and the distant microphone is used to attenuate the sub sequent driving signal.

13. The electronic device of claim 12, where output from the near-speaker microphone and the distant microphone is analyzed to filter out ambient noise, and where such filtered output is analyzed to determine whether or not the speaker is producing a distorted output.

14. The electronic device of claim 11, where determining whether the recorded output varies from the expected output by more than a threshold is determined with reference to a loudspeaker model stored in a memory location of the electronic device.

15. The electronic device of claim 11, where determining whether the recorded output varies from the expected output by more than a threshold includes using audio recorded by multiple microphones.

16. The electronic device of claim 11, where attenuating the subsequent driving signal includes attenuating it only at specific frequencies.

17. The electronic device of claim 11, where attenuating the subsequent driving signal includes an overall gain attenuation.

18. A method of protecting a speaker system of an electronic device against damage, the method comprising:
applying a driving signal to the speaker system to thereby generate an audio output from the speaker system;
recording the audio output and ambient noise with a first microphone of the electronic device;
using output recorded by a second microphone, filtering out the ambient noise from the recorded output obtained by the first microphone, to thereby obtain a filtered output;
processing the filtered output to determine whether and how the filtered output varies from an expected output which would occur in the absence of distortion; and
if the filtered output varies from the expected output by more than a threshold, attenuating an immediately subsequent driving signal prior to applying that subsequent driving signal to the speaker system.

19. The method of claim 18, where the attenuating includes attenuating only at specific frequencies.

20. The method of claim 18, where a pilot tone and its expected output are used to assess whether distortion is present.
